(19) United States
(12) Patent Application Publication
(10) Pub. No.: US 2011/0218378 A1
(43) Pub. Date: Sep. 8, 2011

(54) OFF-PLANET WASTE DISPOSAL SYSTEM AND METHOD

(76) Inventor: Alfonso Adinolfi, Seattle, WA (US)

(21) Appl. No.: 12/788,079

(22) Filed: May 26, 2010

Related U.S. Application Data
(60) Provisional application No. 61/309,545, filed on Mar. 2, 2010.

(51) Int. Cl. B09B 5/00

(52) U.S. Cl. 588/261

(57) ABSTRACT

Systems and methods are provided herein that provide for off-planet waste disposal including elevating waste into space via a space elevator and projecting the waste into the sun so as to dispose of the waste.

### PRIORITY CLAIM

This application claims the benefit of U.S. Provisional Application No. 61/309,545 filed on Mar. 2, 2010, which application is incorporated herein by reference in its entirety for all purposes.

### FIELD

This disclosure relates generally to waste disposal, and more specifically, to off-planet waste disposal systems and methods.

### BACKGROUND

The Earth's reserves of fossil fuels are near exhaustion. Additionally, the byproducts of long-term fossil fuel use is a leading cause of global warming, deterioration of the ozone layer, poisoning of air and fresh water supplies, deforestation, and pollution of the oceans. With world demand growing daily and outpacing production, the push for unrestricted and unregulated exploration to locate and exploit oil reserves is threatening disruption and destruction of the few pristine eco systems left on earth.

Accordingly, alternative energy sources must be developed to keep pace with global demand for energy. Unfortunately, some “zero carbon footprint” options (e.g. wind or solar) do not currently have the potential to satisfy global energy needs in the foreseeable future. On the other hand, nuclear technology has been, and is currently being used successfully to generate non carbon emitting power, and has been doing so for over 50 years.

Nuclear energy has the potential to produce large amounts of clean, non carbon emitting power and the supply of suitable nuclear material is nearly limitless.

However, widespread adoption of nuclear energy technology has seen significant resistance, despite its numerous benefits. Specifically, the opponents of nuclear energy point to the dangers associated with the dangerous materials used to generate nuclear energy, and the dangerous nuclear waste products that result from generating nuclear energy.

For example, opponents of nuclear energy argue that the cost and danger associated with handling, storing and disposing of nuclear waste outweighs the numerous benefits of nuclear energy.

Although technology associated with the handling, storing and disposing of nuclear waste has improved in recent years, safe and permanent nuclear waste systems and methods do not exist. As long as nuclear waste is on Earth, there is still the danger of contamination or weaponization of such waste.

Additionally, waste disposal is currently limited to destruction or storage of waste on earth. The ability to dispose of waste in space is limited by the inability to move materials and personnel (payload) from the surface of the earth to space. Although it is possible to move payloads into space, the primary limitation of waste disposal in space is the cost (often measured in dollars per pound) of moving payload from the surface of the earth to orbit, to the moon, or to other planets. Currently, the most modern launch systems achieve launch costs no better than $4,000-$10,000 per pound for moving payloads from the ground to low earth orbit.

For example, chemical rockets employing liquid and/or solid fuels are the primary methods used for placing objects in orbit and transferring objects from one orbit to another. To achieve orbit, massive quantities of propellant (oxidizer and fuel) are required. For example, for the U.S. Space Shuttle, 3.8 million pounds of propellant are required. The propellant must be carried with the vehicle as well as the payload as it travels to orbit.

While improvements to rocket performance increase the useful payload fraction a small amount, and increased reusability and ground handling can reduce costs substantially, the cost of moving payload to low earth orbit using chemical rockets will likely, in the foreseeable future, not fall below $1000/lb. Therefore, current methods are not economical for the disposal of waste in space.

### BRIEF DESCRIPTION OF THE DRAWINGS

The present invention will be described by way of exemplary embodiments illustrated in the accompanying drawings in which like references denote similar elements, and in which:

FIGS. 1 and 2 depict a space elevator system in accordance with an embodiment.

FIGS. 3a and 3b depict a waste container and waste container projection system in accordance with an embodiment.

FIG. 4 is a block diagram of a method of waste disposal in accordance with an embodiment.

### DESCRIPTION

Illustrative embodiments presented herein include, but are not limited to waste disposal, and more specifically, to off-planet waste disposal systems and methods

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The term “embodiment” is used repeatedly. The phrase generally does not refer to the same embodiment; however, it may. The terms “comprising,” “having” and “including” are synonymous, unless the context dictates otherwise.

Additionally, as used herein, the term ‘space elevator’ and the like, should be construed to include various systems that provide for elevating a payload via an elongated line from a first position on a planet's surface or proximate to the plant's surface, to a second position further from the planet's surface and the first position.

Various embodiments of a space elevator include an elongated line that extends from a planet's surface to a position in space above the planet's surface. Other embodiments include an elongated line that is positioned above a planet surface and extends to a position in space above the planet's surface. Any similar payload elevating system is within the scope and spirit of the present disclosure.

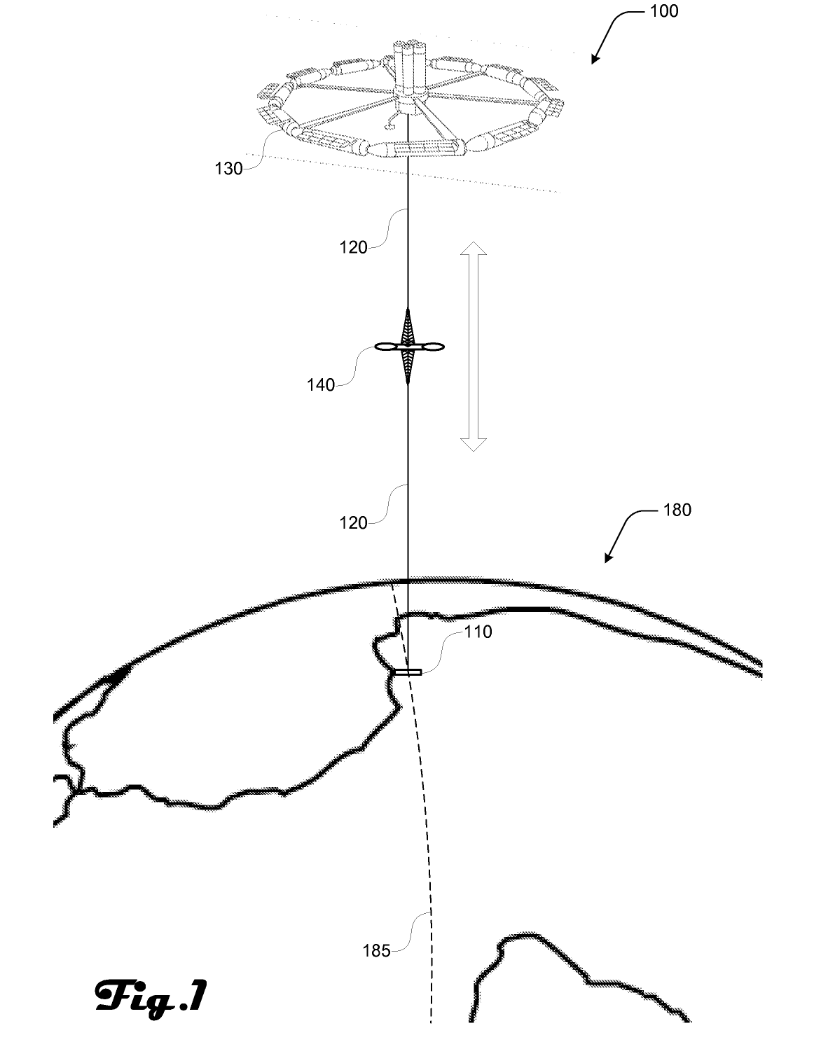

Referring now to FIG. 1, in an embodiment, a space elevator 100 comprises a terrestrial base 110, a line 120, a space station 130, and an elevator vehicle 140, which is operable to travel up and down the line 120 between the terrestrial base 110 and the space station 130. The terrestrial base 110 is disposed on the earth 180, and in various embodiments, the terrestrial base 110 is disposed on the equator 185 of the earth 180.

For example, in an embodiment, the elevator vehicle 140 engages the line 120 to transport a payload along the line 120 of the space elevator 100 to the space station 130 or another point along the line 120. The elevator vehicle 140 may comprise a friction drive motor or other suitable motor.

At the space station 130, or other desired position, the payload may be released, unloaded, or launched as described herein. In various embodiments, this may be a Low Earth Orbit (LEO) representative of some space station operations or low altitude satellites, a Middle Earth Orbit (MEO) consisting of wider range satellites and potential future station activity, Geosynchronous Orbit (GEO) (e.g. 22,500 miles from earth in an equatorial plane) populated largely by communications satellites, or Beyond Earth Orbit (BEO) to a remote destination such as the moon, Mars, or beyond. Earth-bound payloads may follow a similar procedure in reverse.

In some embodiments, the space station 130 may be located in various orbits at various distances from the earth's surface. In further embodiments, a space elevator 100 may comprise a plurality of lines 120 and space stations 130.

### DETAILED DESCRIPTION OF A FIRST SPACE ELEVATOR EMBODIMENT

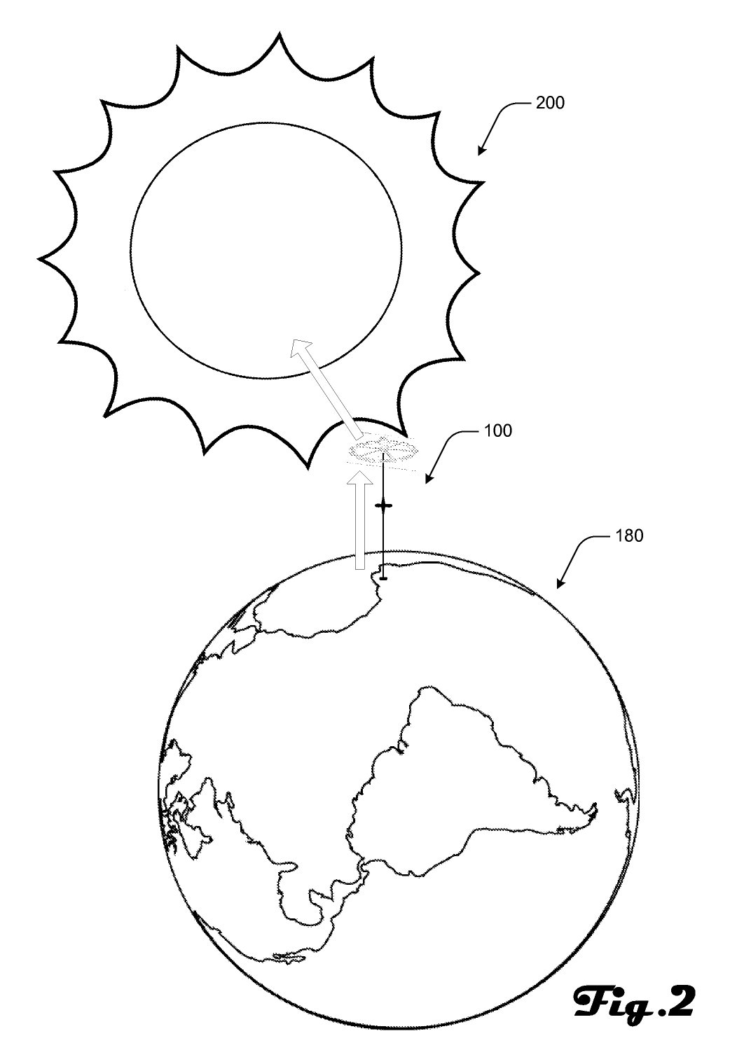

In various embodiments, as depicted in FIGS. 1 and 2, a space elevator 100 may comprise a terrestrial base 110 disposed on the Earth's surface, and a line 120 coupled to the terrestrial base 100 that extends into space and is coupled to space station 130. The line 120 may remain taught between the terrestrial base 110 and space station 130 as described below.

For example, in a rotating coordinate system whose origin is at Earth's center and turning with Earth's daily revolution, the acceleration of any static point in the equator's plane is:

g=−K·M/r²+ω²·r

In the above equation, g is the acceleration along the radius (m s⁻²); K is the gravitational constant (m3 s⁻² kg⁻¹); M is the mass of the Earth (kg); r is the distance from that point to Earth's center (m); ω is Earth's rotation speed (s⁻¹).

Additionally, the ground acceleration g₀ at radius r₀ is given by:

g₀=K·M/r₀²

(the other term is negligible), so that:

K·M=g₀·r₀²

which gives the K·M constant if given the ground acceleration and planet radius.

At some point r₁ above the equator line, the two terms cancel out and provide a geosynchronous trajectory:

r₁=(g₀·r₀²/ω²)^{1/3}

which is to say:

K·M/r₁²=ω²·r₁

which gives the value of r₁.

This is applicable to a planet, satellite, space station 130, or the like.

Accordingly, from the perspective of the space station 130 any point closer from Earth may be accelerated downward, and any point above that would be accelerated toward space. In various embodiments, if a line 120 is dropped “down” (i.e. toward Earth), it may need to be balanced by a line 120 being dropped “up” (away from Earth). Additionally, the mass of the space station 130, at a remote end, may be required for the whole system to remain in geosynchronous orbit. When a line 120 extends to reach the Earth, it can be anchored, for example, at the terrestrial base 110. Once anchored, if further mass is added at the remote end, a tension may thereby be applied to the length of the line 120. Such a line 120 under tension may provide a substrate upon which the elevator vehicle 140 may travel. In various embodiments, the line may be a length of 35000 km, or 22,000 miles.

A space elevator line 120 may be required to support its own weight as well as the weight of an elevator vehicle 140. The required strength of the line 120 may vary along its length, because at various points the line 120 may need to carry the weight of the line portion below, or to provide a centripetal force to retain the line 120, and counterweight above (e.g. space station 130). The line 120 may be made of a material with a large tensile strength/mass ratio. In various embodiments, carbon nanotubes may be used for a material of the line 120.

One line 120 design factor other than the material is the taper ratio, that is, the ratio and taper rate of the cross sectional area of the line 120 as it goes from geosynchronous orbit to ground level. (e.g. from the space station 130 to the terrestrial base 110). In various embodiments, it may be desirable for the line 120 cross section area to be proportional to the maximum force the line 120 would need to withstand. For example, it may be desirable for such a cross-section to follow the following differential equation:

σ·dS=g·ρ·S·dr

In this equation, g is the acceleration along the radius (m·s⁻²); S is the cross-area of the line 120 at any given point r; (m²) and dS its variation (m2 as well); ρ is the density of the material used for the line (kg·m⁻³); σ is the traction a given area can bear without splitting (N·m⁻²=kg·m⁻¹·s⁻²), its elastic limit.

The value of g is given by the first equation, which yields:

Δ[ln(S)]ᵣ₁^{r0}=ρ/σ·Δ[K·M/r+ω²·r²/2]ᵣ₁^{r0}

The variation being taken between r₁ (geostationary) and r₀ (ground).

Between these two points, this quantity may be expressed simply as:

Δ[ln(S)]=ρ/σ·g₀·r₀·(1+x/2−3/2·x^{1/3}),

or

S₀S₁·e^{ρ/σ·g0·r0·(1+x/2-3/2·x}^{^{1/3}}⁾

where x=ω²·r₀/g₀ is the ratio between the centrifugal force on the equator and the gravitational force.

Accordingly, the factor that has the main influence is g₀ r₀, i.e. the combination of the planet's radius and its surface gravity. In various embodiments, the rotational speed may be minimally influential. For Earth, for example, the rotational speed reduces the strength needed by about one third. In various embodiments, the line 120 is a ribbon (i.e. a flat elongated sheet) or may be cylindrical, or the like.

In some embodiments, the terrestrial base 110 may be mobile or stationary. In an embodiment, a mobile terrestrial base 110 may be an ocean-going vessel such as a ship or a specialized platform structure. In some embodiments, it may be desirable for a stationary platform to be located in high-altitude locations, such as on top of mountains, towers, buildings or the like.

A mobile terrestrial base 110 may have the advantage of being able to maneuver to avoid high winds, storms, and space debris. A stationary terrestrial base 110 may have access to cheaper and more reliable power sources, and require a shorter line 120.

Various embodiments envision an elevator vehicle 140 that “climbs” the line 120. Other embodiments may include moving lines 120.

In an embodiment where a line 120 is a planar ribbon, for example, pairs of rollers may be implemented to hold the line 120 with friction. In some embodiments, an elevator vehicle 140 may be optimized for upwards movement so as to oppose the force of gravity.

The horizontal speed of each part of the line 120 may increase with altitude, proportional to distance from the center of the Earth, reaching orbital velocity at geostationary orbit. Therefore, in some embodiments, as a payload is lifted up a space elevator 100, the payload and an elevator vehicle 140 may need to gain not only altitude but angular momentum (horizontal speed) as well. This angular momentum may be taken from the Earth's own rotation. As an elevator vehicle 140 ascends it may initially move more slowly than the line 120 that it moves onto (Coriolis force) and thus an elevator vehicle 140 may generate “drag” on the line 120.

In various embodiments, the overall effect of the centrifugal force acting on the line 120 may cause the line 120 to constantly try to return to an energetically favorable vertical orientation. Accordingly, after a payload has been lifted on the line 120 a counterweight (e.g. the space station 130) may swing back towards the vertical like an inverted pendulum. Where a space elevator 100 is designed so that the center of weight always stays above geostationary orbit for the maximum climb speed of the elevator vehicle 140, the space elevator 100 may resist falling.

In various embodiments, once a payload has reached geosynchronous orbit, the angular momentum (horizontal speed) may be enough that the payload is in orbit. In some embodiments, a second line (not shown) may be attached to a platform to lift payload up a main line 120, since an elevator vehicle 140 would not have to deal with its own weight against Earth's gravity.

In an embodiment, an elevator vehicle 140 may be powered by transfer of energy to the elevator vehicle 140 through wireless energy transfer while it is climbing; by transfer of the energy to the an elevator vehicle 140 through a material structure while it is climbing; by storing the energy in an elevator vehicle 140, or the like.

Some embodiments may implement nuclear energy or solar power. Further embodiments implement laser power beaming, using e.g. megawatt powered free electron or solid state lasers in combination with adaptive mirrors and a photovoltaic array on the elevator vehicle 140 tuned to the laser frequency. Still further embodiments implement various mechanical means of applying power such as moving, looped or vibrating lines 120.

In the exemplary embodiment depicted in FIGS. 1 and 2, a space station 130 may act as a counterweight. However, in further embodiments, a counterweight may include a captured asteroid, a space dock, an extension of the line 120 itself far beyond geostationary orbit, or the like.

In embodiments comprising a space station 130, numerous configuration of space stations may be suitable. Such a space station 130 may or may not have the capacity to house people.

### DETAILED DESCRIPTION OF A SECOND SPACE ELEVATOR EMBODIMENT

As discussed herein, some embodiments of a space elevator 100 may not be coupled with the surface of a planet or be in contact with the surface of the planet. For example, U.S. Pat. No. 6,491,258 to Boyd teaches such a system. U.S. Pat. No. 6,491,258 is hereby incorporated by references in its entirety as if fully set forth herein.

As shown in Boyd, and referring to FIG. 1 therein, a Space Elevator may include an Apex Station, a lower altitude Earth Transfer Station (ETS), a higher altitude Space Transfer Station (STS), an upper elevator and a lower elevator. Cables connect the Apex Station and the Earth Transfer Station and Space transfer Station endpoint stations to each other.

The upper and lower elevator carriages may move between the end point stations and the Apex Station via the line. No portion of the Space Elevator is attached to the Earth's surface. Space bound payloads are delivered to the Earth Transfer Station by a vehicle launched from the earth's surface. At the Earth Transfer Station, the payloads are transferred from a SOLV 200 to an elevator carriage. The elevator carriage then transports the payload along the cable of the Space Elevator to either the Apex Station or Space Transfer Station.

At either station, the payload may be released into free space in a Low Earth Orbit (LEO) representative of space station operations or low altitude satellites, a Middle Earth Orbit (MEO) consisting of wider range satellites and potential future station activity, Geosynchronous Orbit (GEO) (approximately 22,500 miles from earth in an equatorial plane) populated largely by communications satellites, or Beyond Earth Orbit (BEO) to a remote destination such as the moon, Mars, or beyond. Earth-bound payloads follow a similar procedure in reverse.

### DESCRIPTION OF OFF-PLANET WASTE DISPOSAL SYSTEMS AND METHODS

In an embodiment, waste or other matter may be disposed of via a space elevator 100 as depicted in FIG. 2. For example, radioactive waste may be collected, loaded as a payload onto an elevator vehicle 140, and elevated into space. Containers comprising the radioactive waste may then be propelled into the sun 200.

In one embodiment, waste may be loaded into a suitable transport container. This may occur at the location where the waste is generated (e.g. nuclear power plant) or may occur in proximity to the terrestrial base 110. Additionally, waste may initially be contained in a first container, and then contained in a second container for transport on the space elevator. Waste may also be contained in a suitable transport container for travel into the sun or other disposal destination. The waste may be re-packaged into any of the second container or third container, or the first container may be placed into the second container, which may be placed into the third container, or the like. In various embodiments, the same container may be used throughout the disposal process.

For example, on one embodiment, earth-transport container may be filled with waste at a waste site and the earth-transport containers may be transported to a space elevator 100, where they are loaded onto an elevator vehicle 140. In some embodiments, a plurality of earth-transport containers may be loaded into the elevator vehicle 140 at once, or a single earth-transport container may be loaded into the elevator vehicle 140 at a time.

In another example, waste from earth-transport containers may be unloaded and loaded into space-elevator transport containers or containers that may ultimately be projected to an off-planet disposal location.

In a further example, one or more container that is ultimately projected to an off-planet disposal location can be filled with waste at a waste location, transported to a space elevator 100, lifted into space, and projected to a disposal location. Such a container may be fitted with propulsion and/or guidance systems at various times, including at a waste location, at a space elevator, while traveling up into space, at the space station 140, and the like.

Additionally, a suitable container may vary depending on the type of waste being contained therein. For example, radioactive waste may be contained differently than biological waste, or may be contained differently than harmless commercial or household waste. Containers may be any suitable size and shape.

Containers used on a space elevator 100 may also be specialized to provide for safety while moving into space. For example, such containers may be resistant to breakage when falling from great heights in the atmosphere, resistant to extreme temperatures, resistant to the vacuum of space or reduced atmosphere, and the like.

In various embodiments, steps of the waste disposal process may be performed by human operators, by automated systems, or a combination thereof. For example, a waste payload that has reached a desired position in space may be unloaded and projected into the sun robotically, which may or may not include human interaction. In other embodiments, a crew may directly unload and/or launch waste containers. Additionally, as further described herein, projection systems such as guidance and propulsion systems may be coupled with a waste container at that space station 130. Such coupling may be achieved via an automated system, which does not require human intervention.

In an embodiment, waste containers may be projected into the sun (or other disposal destination) in various ways. For example, containers may be projected physically (e.g. slingshot, or catapult) or may be projected via a rocket or other suitable propulsion system. Such a propulsion system may or may not include a targeting system, guidance system, or the like.

Accordingly, the path to a disposal location (e.g. the sun 200) need not be substantially linear, and may be curved or include any suitable desirable path. In some embodiments, it may be necessary to wait for a clear linear path to a disposal location before projection of waste occurs. For example, where a disposal container is inoperable to change its trajectory, projection of waste into the sun could be delayed until a clear trajectory to the sun is obtained at the projection location (e.g. the space station 130). However, in embodiments where a waste container is operable to modify its trajectory (or have its trajectory modified), waste may be projected at various suitable times.

In some embodiments, it may be desirable to implement various safety measures to prevent unintended or accidental weaponization of waste. For example, it may be desirable to dispose of waste such that risk of malicious operators taking control of projectiles comprising nuclear or biological waste is reduced.

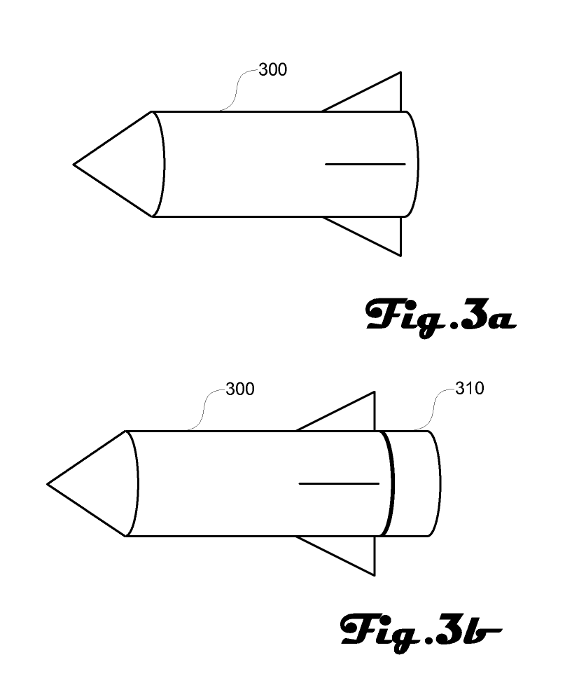

In an embodiment, waste may be transported independent of propulsion of guidance systems. For example, in one embodiment, waste containers may be transported independently up the space elevator, and propulsion systems or guidance systems may be transported separately. Waste containers and such projection systems may only be combined operably when in space, or as close as possible to time of container projection into a disposal location. FIG. 3a depicts an exemplary container 300a, wherein a projection system 310b can be selectively coupled to the container 300a at a desired time, as shown in FIG. 3b.

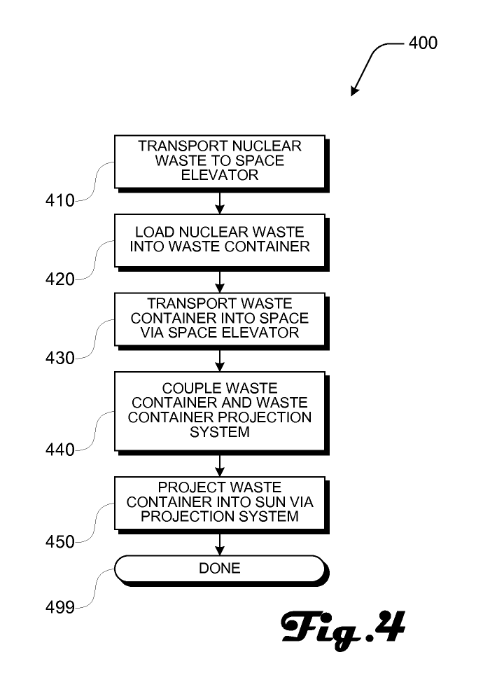

FIG. 4 depicts an exemplary method of waste disposal via a space elevator 100. The method 400 begins in block 410 where nuclear waste is transported to a space elevator 100. In block 420 nuclear waste is loaded into a waste container and in block 430 the waste container is transported into space via the space elevator 100. The waste container and waste container projection system are coupled in block 440. In block 450 the waste container is projected into the sun 200 via the waste projection system and the method 400 ends in block 499.

In some embodiments, the projection system may be transported into space after the waste container. In other embodiments, a projection system may comprise a propulsion system and guidance system, and such systems and/or portions thereof may be transported into space via the space elevator 100 piecemeal.

Additionally, in some embodiments, a waste container may be projected into any suitable sun, be projected into space without a defined destination, or may be projected to a desired planet.

Furthermore, various safety systems may be utilized which make various projection systems inoperable if not armed, combined with a specific container, used within a defined time period, or the like. Also, various portions of a projection system may be made inoperable or destroyed on command, by remote signal, or the like.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A method of disposing of hazardous waste in the sun, the method comprising:
loading hazardous waste into a waste container on earth;
transporting the waste container to a space elevator;
elevating the waste container into space via the space elevator; and
propelling the waste container into the sun to dispose of the waste.

2. The method of claim 1, wherein the space elevator comprises:
a terrestrial base disposed on earth;
a space station in substantially geosynchronous orbit around the earth over the terrestrial base;
a line extending from the terrestrial base to the space station; and
an elevator vehicle operable to ascend the line from the terrestrial base to the space station while carrying a payload comprising the hazardous waste container.

3. The method of claim 2, wherein the space station comprises an automated system operable to unload the waste container from the elevator vehicle without human intervention.

4. The method of claim 1, further comprising:
transporting a waste container projection system into space via the space elevator; and
coupling the waste container and the container projection system,
wherein said propelling occurs substantially via the container projection system.

5. The method of claim 4, wherein the waste container and waste container projection system are not transported contemporaneously on the space elevator.

6. The method of claim 4, wherein the waste container projection system is inoperable when not coupled with the waste container.

7. The method of claim 4, further comprising a second waste container, and wherein the waste container projection system is operable when coupled with the first waste container and inoperable when coupled with the second waste container.

8. The method of claim 1, wherein the hazardous waste is nuclear waste.

9. A system for disposing of hazardous waste in the sun, the system comprising:
a waste container operable to safely contain hazardous waste;
a space elevator that comprises:
a terrestrial base disposed on earth;
a space station in substantially geosynchronous orbit around the earth over the terrestrial base;
a line extending from the terrestrial base to the space station; and
an elevator vehicle operable to ascend the line from the terrestrial base to the space station while carrying a payload comprising the hazardous waste container.

10. The system of claim 9 wherein the space station comprises an automated system operable to unload the waste container from the elevator vehicle without human intervention.

11. The system of claim 9, further comprising a waste container projection system operable to be coupled with the waste container.

12. The system of claim 11, wherein the waste container projection system is inoperable when not coupled with the waste container.

13. The system of claim 11, wherein the waste container projection system is inoperable when not coupled with the waste container in space.

14. The system of claim 11, further comprising a second waste container, and wherein the waste container projection system is operable when coupled with the first waste container and inoperable when coupled with the second waste container.

15. The system of claim 9, wherein the hazardous waste is nuclear waste.

16. The system of claim 9, wherein the space station is operable to project the waste container into the sun.

17. The system of claim 16, wherein the waste container is operable to project itself into the sun.

18. The system of claim 11 further comprising an automated system operable to couple the waste container and the waste container projection system without human intervention.
